(19) United States
(12) Patent Application Publication
(10) Pub. No.: US 2012/0187221 A1
(43) Pub. Date: Jul. 26, 2012

(54) Liquid jet head, liquid jet apparatus, and method of manufacturing the liquid jet head

(76) Inventors: Tetsuya Murase, Chiba-shi (JP); Tomoharu Hagiwara, Chiba-shi (JP)

(21) Appl. No.: 13/374,871

(22) Filed: Jan. 19, 2012

(30) Foreign Application Priority Data
Jan. 21, 2011 (JP) 2011-011228

(51) Int. Cl. B05B 1/14; B29C 65/48; B05B 1/00; B29C 65/00

(52) U.S. Cl. 239/590; 156/245; 239/589

(57) ABSTRACT

To prevent ejection failure which occurs because openings of nozzles are clogged with fine burrs generated at a parting line (P) of a flow path member (2) formed by molding, provided is a liquid jet head (1) including the flow path member (2) and an actuator portion (3). The flow path member (2) includes a first member (4) and a second member (5) bonded thereto. A flow path (8) and a discharge port (12) communicated to the flow path (8) are formed between the first member (4) and the second member (5). The first and second members (4, 5) each include a parting line formed by molding on a surface thereof. The parting line is not positioned on an inner surface forming the flow path (8), and is positioned on the surface of the first member (4) or the second member (5) other than the inner surface.

### BACKGROUND OF THE INVENTION

1. Field of the Invention

The present invention relates to a liquid jet head including a flow path member for supplying liquid to an actuator portion, and more particularly, to a liquid jet head capable of preventing ejection failure which occurs because fine dust from the flow path member is mixed into liquid to be ejected, a liquid jet apparatus which uses the liquid jet head, and a method of manufacturing the liquid jet head.

2. Description of the Related Art

In recent years, there has been used an inkjet type liquid jet head which ejects ink droplets onto recording paper and the like to draw letters and diagrams, or ejects a liquid material onto a surface of an element substrate to form a functional thin film. The liquid jet head of this type is supplied with ink or a liquid material from a liquid tank via a supply tube, and is caused to eject the ink or the liquid material filled in channels thereof from nozzles communicated to the channels. At the time of ink ejection, the liquid jet head and a recording medium for recording the jetted liquid are moved, to thereby record the letters and diagrams or form the functional thin film in a predetermined shape (for example, see Japanese Patent Application Laid-open No. 2009-107225).

FIG. 13 is a perspective view of a flow path member 100 to be used in a liquid jet head of this type. FIG. 14 is a schematic view illustrating a longitudinal section of the liquid jet head in which the flow path member 100 is bonded to an actuator portion 120. The flow path member 100 in FIG. 14 is a longitudinal section taken along the line AA of FIG. 13.

The flow path member 100 is an intermediate member for supplying ink stored in a tank to the actuator portion 120, and is formed of a synthetic resin such as polyphenylene sulfide (PPS). As illustrated in FIGS. 13 and 14, the flow path member 100 is formed of two members corresponding to a first member 101 and a second member 102. The first member 101 includes a supply connection portion 106 provided on an upper surface thereof, to which liquid such as ink is supplied, three engagement claws 112a provided on a front side surface thereof, and three engagement holes 113b provided on a rear side surface thereof. To an inner upper surface of the first member 101, a filter 103 is attached in proximity to a supply port 114.

The second member 102 includes a discharge port 105 provided on a front side surface thereof, for discharging liquid supplied from the supply port 114, engagement holes 113a provided above the discharge port 105, with which the engagement claws 112a engage, and engagement claws 112b provided on a rear side surface thereof, which engage with the engagement holes 113b. The first member 101 and the second member 102 are bonded to each other to be watertight with an adhesive. The flow path member 100 discharges the liquid supplied from the supply port 114 from the discharge port 105 via a flow path 110.

The actuator portion 120 includes a pressure application portion 121 having a pressure chamber 122 formed therein, a nozzle plate 123 bonded to an end portion of the pressure chamber 122, and a support member 124 for supporting the pressure application portion 121. An end portion of the pressure application portion 121 and an end portion of the flow path member 100 are adhered to each other with an adhesive 116 so that an inflow port 126 and the discharge port 105 are communicated to each other. The actuator portion 120 applies pressure to the liquid flowing in from the inflow port 126 to eject liquid droplets from nozzles 125, thereby recording the liquid droplets to a recording medium (not shown).

The filter 103 is provided to remove air bubbles and dust included in the liquid supplied from the supply port 114. The removal is performed because, if the air bubbles and dust enter the flow path 110, the openings of the nozzles 125 are closed, which makes it impossible to normally eject the liquid droplets. Therefore, it is necessary to perform control so that air bubbles and dust do not enter the flow path 110 on a downstream side with respect to the filter 103.

Note that, Japanese Patent Application Laid-open No. 2009-107225 describes means for smoothly guiding ink adhered to a platen. When ink is ejected from a recording head in an ink jet type image recording apparatus, an ink mist is generated accordingly. When the ejected ink or the ink mist adheres to and accumulates on the platen, it causes contamination of the recording paper or the like. In particular, the platen is formed by molding of a synthetic resin. At the time of molding, a step due to a parting line is formed at a boundary between two molds. When a stepped portion due to the parting line exists in a middle of a flow path which is formed when the adhesion amount of the ejected ink or the ink mist increases and the ink flows out from the front surface to the rear surface of the platen, the ink accumulates at the stepped portion to contaminate the recording paper or deteriorate the recording quality. As a countermeasure, a slit which passes through from the front surface to the rear surface of the platen is formed. A V-shaped guide path for guiding the ink is formed on a side surface of the slit on the front surface side, and a flat surface is formed on a side surface of the slit on the rear surface side. Then, a parting surface at which the two molds meet each other is provided at a boundary between the V-shaped surface and the flat surface, and thus an ink guide portion, which has no step between the V-shaped surface and the flat surface, is formed. The ink flows on the ink guide portion without accumulation, and hence contamination of the recording paper and deterioration of the recording image are prevented.

The first and second members 101 and 102 are formed by molding using a plurality of molds. The plurality of molds are used, and hence parting lines are formed on a surface of a molded product at boundaries between the molds. A gap at the boundary between the molds cannot be completely eliminated, and hence fine burrs remain at the parting lines of the molded product. Therefore, when the parting lines are exposed to the flow path, the fine burrs generated at the parting lines drop off from the flow path member to close opening portions of the nozzles 125 and cause ejection failure. In particular, the ejection failure occurs when the parting line is positioned on an inner surface on a downstream side with respect to the filter 103.

Specific description is given below. FIGS. 15A and 15B illustrate a method of forming the first and second members 101 and 102 by molding. FIG. 15A illustrates a method of molding the first member 101, and FIG. 15B illustrates a method of molding the second member 102. The first member 101 is formed using three molds corresponding to a first mold 131, a second mold 132, and a third mold 133. The first mold 131 and the third mold 133 are used to form the front portion and the upper portion of the main body, the engagement claws 112a, the supply connection portion 106, and the supply port 114. The second mold 132 and the third mold 133 are used to form the rear portion of the main body and the engagement holes 113b. Therefore, an eighth parting line L8 is formed at a boundary between the first mold 131 and the third mold 133, an eleventh parting line L11 is formed at a boundary between the first mold 131 and the second mold 132, and a ninth parting line L9 and a tenth parting line L10 are formed at boundaries between the second mold 132 and the third mold 133.

The second member 102 is formed using three molds corresponding to a fourth mold 134, a fifth mold 135, and a sixth mold 136. That is, the fourth mold 134 and the fifth mold 135 are used to form the discharge port 105 and the engagement holes 113a, and the fourth mold 134 and the sixth mold 136 are used to form the main body portion of the second member 102 and the engagement claws 112b. Therefore, first to fifth parting lines L1 to L5 are formed at boundaries between the fourth mold 134 and the fifth mold 135, a sixth parting line L6 is formed at a boundary between the fifth mold 135 and the sixth mold 136, and a seventh parting line L7 is formed at a boundary between the fourth mold 134 and the sixth mold 136.

As illustrated in FIG. 14, when the first member 101 and the second member 102 are bonded to each other to form the flow path member 100, the third to eleventh parting lines L3 to L11 are positioned at a bonding surface between the first member 101 and the second member 102 or an outer surface of the flow path member 100, but the first parting line L1 and the second parting line L2 are exposed to the flow path 110 on the downstream side with respect to the filter 103. Accordingly, the ejection failure is caused when the fine burrs drop off from the first parting line L1 and the second parting line L2 and close the openings of the nozzles 125. The present invention provides a liquid jet head capable of preventing such a failure.

### SUMMARY OF THE INVENTION

A liquid jet head according to the present invention includes: a flow path member including a first member and a second member bonded to the first member, the first member and the second member forming a flow path and a discharge port communicated to the flow path between the first member and the second member; and an actuator portion, into which liquid discharged from the discharge port flows, for ejecting the liquid from a plurality of nozzles, in which: the first member and the second member each include a parting line formed by molding on a surface thereof; and the parting line is positioned on the surface of one of the first member and the second member other than an inner surface forming the flow path.

Further, in the liquid jet head according to the present invention: the discharge port opens on an end surface of the flow path member; and the parting line is positioned on the end surface.

Further, in the liquid jet head according to the present invention: the actuator portion includes an inflow port at an end surface thereof; the end surface of the actuator portion and the end surface of the flow path member are bonded to each other with an adhesive; and the parting line positioned on the end surface of the flow path member is covered with the adhesive.

Further, in the liquid jet head according to the present invention, the end surface of the flow path member includes a groove, which is provided so as to surround the discharge port, for causing the adhesive to flow.

Further, in the liquid jet head according to the present invention: the first member includes a supply port communicated to the flow path and a filter provided on a downstream side with respect to the supply port; and the inner surface is a surface positioned on a downstream side with respect to the filter on the discharge port side.

A liquid jet apparatus according to the present invention includes: any one of the liquid jet heads described above; a moving mechanism for reciprocating the liquid jet head; a liquid supply tube for supplying liquid to the liquid jet head; and a liquid tank for supplying the liquid to the liquid supply tube.

A method of manufacturing a liquid jet head according to the present invention includes: a first molding step of filling a synthetic resin into a space defined by a first mold, a second mold, and a third mold to mold a first member; a second molding step of filling a synthetic resin into a space defined by a fourth mold and a fifth mold to mold a second member; a first bonding step of bonding the first member and the second member so that a flow path and a discharge port communicated to the flow path are formed between the first member and the second member, to thereby form a flow path member; and a second bonding step of bonding an end surface of the flow path member, on which the discharge port opens, and an end surface of an actuator portion, on which an inflow port opens, with an adhesive, in which: the first molding step includes forming a first parting line on a surface of the first member other than an inner surface forming the flow path, the first parting line being formed at a boundary between any two of the first mold, the second mold, and the third mold; and the second molding step includes forming a second parting line on a surface of the second member other than the inner surface forming the flow path, the second parting line being formed at a boundary between the fourth mold and the fifth mold.

Further, in the method of manufacturing a liquid jet head according to the present invention: the first molding step includes forming the first parting line on the end surface on which the discharge port opens; and the second molding step includes forming the second parting line on the end surface on which the discharge port opens.

Further, in the method of manufacturing a liquid jet head according to the present invention, the first bonding step includes covering the second parting line with the first member and covering the first parting line with the second member.

Further, in the method of manufacturing a liquid jet head according to the present invention, the second bonding step includes embedding the first parting line and the second parting line, which are formed on the end surface on which the discharge port opens, in the adhesive.

Further, the method of manufacturing a liquid jet head according to the present invention further includes, after the first molding step, a filter providing step of providing a filter to the first member.

Further, in the method of manufacturing a liquid jet head according to the present invention, the first mold and the fourth mold include an elongated protrusion on surfaces thereof, which correspond to the end surface on which the discharge port opens.

The present invention provides the liquid jet head, including: the flow path member including the first member and the second member bonded to the first member, the first member and the second member forming the flow path and the discharge port communicated to the flow path between the first member and the second member; and the actuator portion, into which liquid discharged from the discharge port flows, for ejecting the liquid from the plurality of nozzles, in which the flow path member is formed so that the parting line formed by molding is positioned on the surface of the first member or the second member other than the inner surface forming the flow path. With this structure, the parting line, which is formed at the boundary between the molds, is not positioned on the inner surface of the flow path member forming the flow path. Therefore, it is possible to prevent the ejection failure which occurs because the nozzles are clogged with fine burrs generated at the parting line.

### BRIEF DESCRIPTION OF THE DRAWINGS

In the accompanying drawings:

FIG. 1 is a schematic view illustrating a longitudinal section of a liquid jet head according to a first embodiment of the present invention;

FIG. 2 is a view illustrating positions of parting lines of a flow path member used in the first embodiment;

FIGS. 3A and 3B are a perspective view and an exploded perspective view, respectively, of the flow path member used in the first embodiment, when viewed obliquely from above;

FIG. 4 is an exploded perspective view of the flow path member used in the first embodiment, when viewed obliquely from below;

FIG. 5 is a schematic perspective view illustrating a discharge-port-side end surface of the flow path member used in the first embodiment;

FIG. 6 is a process chart illustrating basic steps of a method of manufacturing a liquid jet head according to the present invention;

FIGS. 7A and 7B are views illustrating a method of manufacturing a liquid jet head according to a second embodiment of the present invention;

FIGS. 8A and 8B are views illustrating the method of manufacturing a liquid jet head according to the second embodiment of the present invention;

FIG. 9 is a longitudinal sectional view of a first member obtained after a filter providing step of the second embodiment;

FIG. 10 is a longitudinal sectional view of a flow path member obtained after a first bonding step of the second embodiment;

FIG. 11 is a longitudinal sectional view of the flow path member and an actuator portion obtained after a second bonding step of the second embodiment;

FIG. 12 is a schematic perspective view of a liquid jet apparatus according to a third embodiment of the present invention;

FIG. 13 is a perspective view of a flow path member to be used in a conventionally well-known liquid jet head;

FIG. 14 is a schematic view illustrating a longitudinal section of the conventionally well-known liquid jet head; and

FIGS. 15A and 15B are views illustrating a method of forming the flow path member by a conventionally well-known molding method.

### DETAILED DESCRIPTION OF THE PREFERRED EMBODIMENTS

### Liquid Jet Head

A liquid jet head according to the present invention includes a flow path member and an actuator portion. The flow path member is an intermediate member for discharging liquid supplied from a liquid tank to the actuator portion. The actuator portion ejects the liquid flowing in from the flow path member from nozzles, to thereby record liquid droplets onto a recording medium. The flow path member includes a first member formed by molding and a second member formed by molding, the second member being bonded to the first member. The first member and the second member are bonded to each other so that a flow path and a discharge port communicated to the flow path are formed therebetween. The actuator portion includes an inflow port into which the liquid from the discharge port flows, and the nozzles for ejecting the liquid.

Here, the first and second members each have a parting line formed by the molding on a surface thereof. The parting line is positioned on the surface of the first member or the second member other than an inner surface forming the flow path. That is, the surface on which the parting line is formed does not form the flow path, and hence fine burrs, which are generated at the parting line and drop off from the flow path member, are not mixed into the liquid flowing through the flow path. Therefore, it is possible to prevent ejection failure which occurs because the nozzles are clogged with the fine burrs.

Note that, a boundary between the inner surface of the flow path member, which forms the flow path, and an outer surface thereof, which does not form the flow path, is included in the outer surface. Generally, the boundary between the inner surface and the outer surface is provided with an adhesive. Even if a parting line is positioned at the boundary between the inner surface and the outer surface, the parting line is covered with the adhesive, and thus the parting line is unexposed to the flow path. Therefore, the fine burrs are not mixed into the liquid. Hereinafter, specific description is given with reference to the drawings.

### First Embodiment

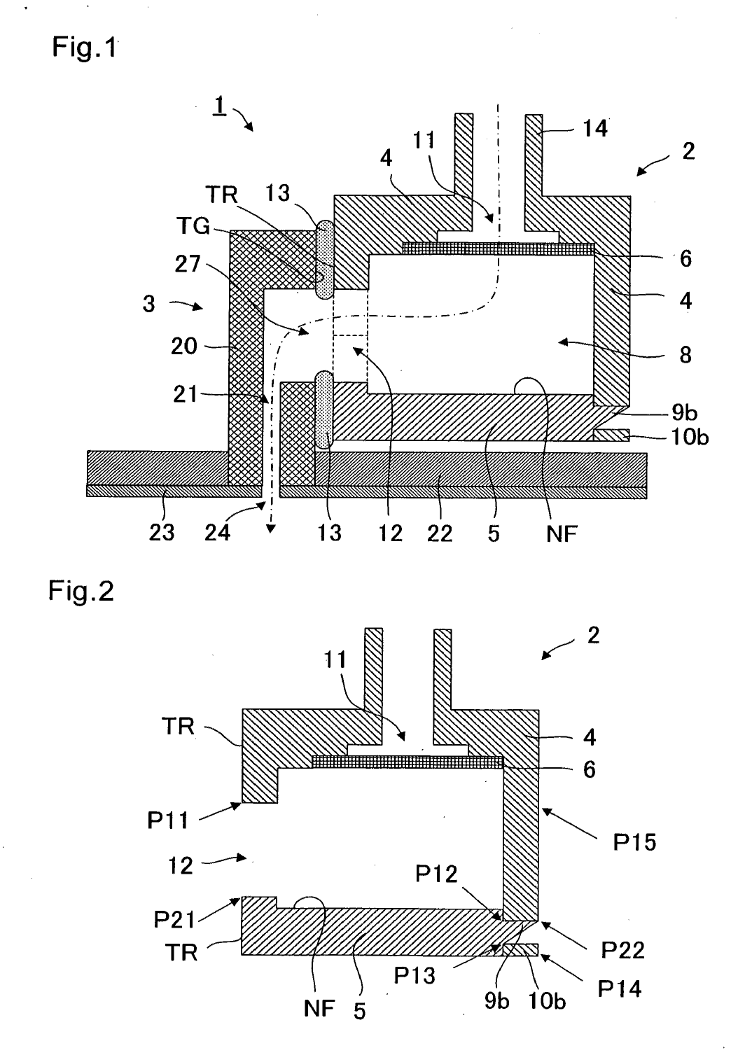

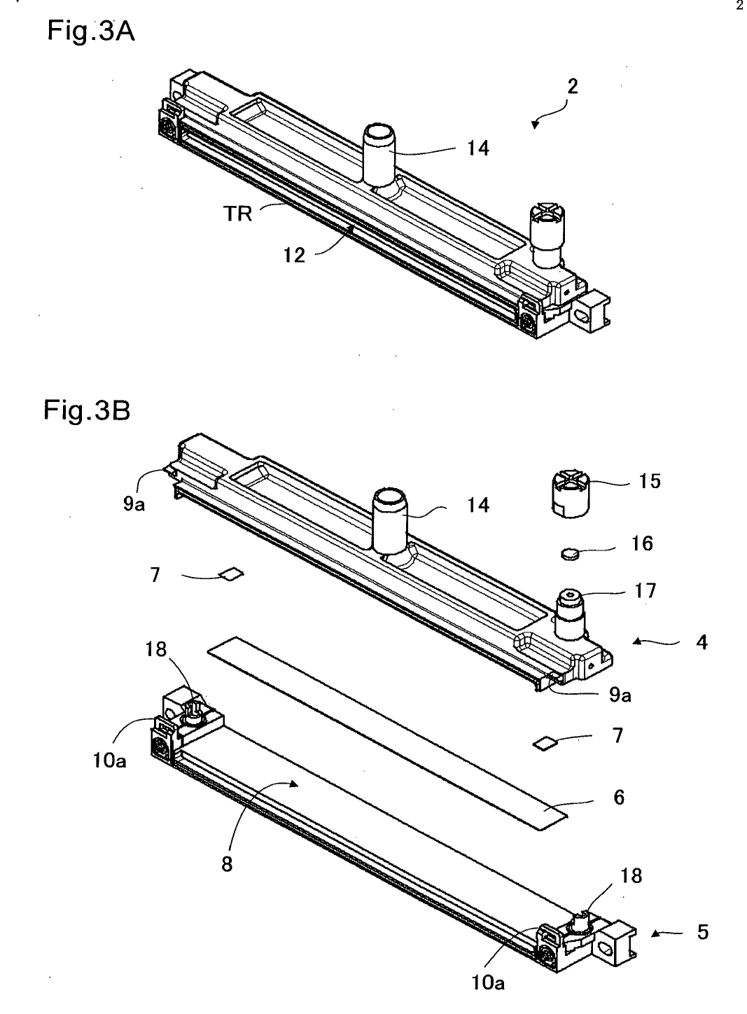

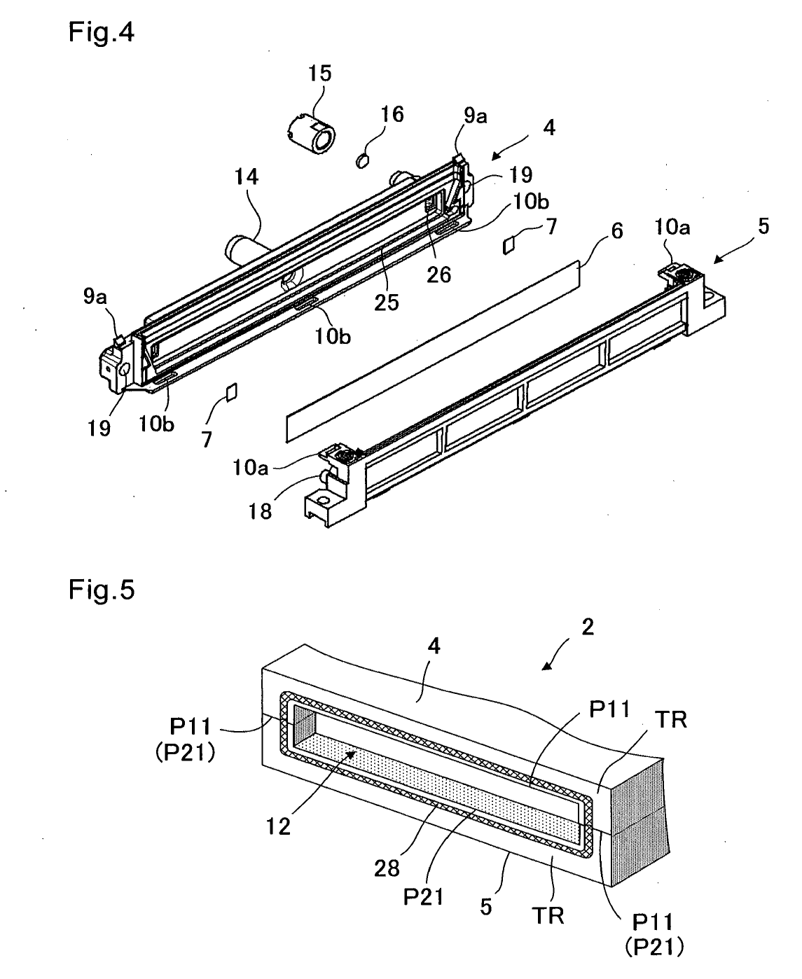

FIG. 1 is a schematic view illustrating a longitudinal section of a liquid jet head 1 according to a first embodiment of the present invention. FIG. 2 illustrates positions of parting lines of a flow path member 2. FIGS. 3A and 3B are a perspective view and an exploded perspective view, respectively, of the flow path member 2 used in the first embodiment, when viewed obliquely from above. FIG. 4 is an exploded perspective view of the flow path member 2 used in the first embodiment, when viewed obliquely from below.

As illustrated in FIG. 1, the liquid jet head 1 includes the flow path member 2, and an actuator portion 3 bonded to the flow path member 2 with an adhesive 13. The flow path member 2 includes a first member 4 and a second member 5 bonded to the first member 4. The first member 4 and the second member 5 form a flow path 8 and a discharge port 12 therebetween.

The first member 4 includes, on an upper surface thereof, a supply port 11 for supplying liquid, a supply connection portion 14 connected to the supply port 11, and, on a side surface lower portion on a rear surface side, engagement holes 10b. The first member 4 further includes a first filter 6 attached on an inner surface NF in proximity to the supply port 11. The second member 5 includes engagement claws 9b at a rear end thereof, and the engagement claws 9b engage with the engagement holes 10b of the first member 4 to fix the first member 4 and the second member 5 to each other.

The actuator portion 3 includes a pressure application portion 20 forming a pressure chamber 21, and a support member 22 and a nozzle plate 23 provided at an end portion of the pressure chamber 21. The pressure chamber 21 is communicated to the discharge port 12 via an inflow port 27. An inflow-port-side end surface TG of the pressure application portion 20, on which the inflow port 27 opens, and a discharge-port-side end surface TR of the flow path member 2, on which the discharge port 12 opens, are bonded to each other with the adhesive 13. The nozzle plate 23 is bonded to an end portion of the pressure application portion 20 and the support member 22. The nozzle plate 23 includes a plurality of nozzles 24 communicated to the pressure chamber 21, the nozzles 24 being arranged in a direction perpendicular to the drawing sheet. Liquid pressurized in the pressure chamber 21 is ejected from the nozzles 24. Note that, the second member 5 and the support member 22 may be or not be bonded to each other.

FIG. 2 illustrates the parting lines of the first and second members 4 and 5 formed by molding. The first member 4 has first parting lines P11 to P15 positioned at an opening end portion of the discharge port 12, corner portions of the engagement hole 10b, a lower portion on the rear surface side, and an outer surface of a center portion, respectively. The second member 5 has second parting lines P21 and P22 positioned at the opening end portion of the discharge port 12 and a leading end portion of the engagement claw 9b, respectively. Among those parting lines, the first parting lines P12 and P13 are positioned at a bonding surface between the first member 4 and the second member 5, and the second parting line P22 and the first parting lines P14 and P15 are positioned on the outer surface of the flow path member 2, and hence those parting lines are unexposed to the flow path 8. Further, the first and second parting lines P11 and P21 at the opening end portion of the discharge port 12 are included in the outer surface of the flow path member 2, and are embedded in the adhesive 13 bonding the flow path member 2 and the actuator portion 3 to each other. Therefore, the parting lines are not positioned on the inner surface NF of the first and second members 4 and 5 forming the flow path 8. As a result, fine burrs, which are generated at the parting lines and drop off from the flow path member, are not mixed into the liquid flowing through the flow path.

Further, the first filter 6 is provided in the vicinity of the supply port 11, and hence fine burrs or dust generated at the parting lines or the like can be removed. In other words, it is only necessary not to position the parting lines on a downstream side with respect to the first filter 6 on the discharge port 12 side. In this case, the inner surface forming the flow path refers to surfaces of the first and second members 4 and 5 on the flow path side, which are on the downstream side with respect to the first filter Note that, the discharge port 12 is formed between the first member 4 and the second member 5, and hence the first parting line P11 and the second parting line P21 are always positioned at the discharge-port-side end surface TR.

The flow path member 2 is described in more detail with reference to FIGS. 3A, 3B, and 4. As illustrated in FIG. 3A, the flow path member 2 has a shape elongated in a lateral direction. The flow path member 2 includes the discharge port 12 opened at the discharge-port-side end surface TR on the front side surface thereof, and the supply connection portion 14 provided at a center of the upper surface thereof. The discharge-port-side end surface TR is bonded to the inflow-port-side end surface TG of the actuator portion 3 (not shown) with the adhesive 13 (see FIG. 1). As illustrated in FIGS. 3B and 4, in the flow path member 2, by bonding the first member 4 and the second member 5 to each other, the flow path 8 and the discharge port 12 are formed between the first member 4 and the second member 5. The first member 4 includes, in an inner surface thereof, a first filter receiving portion 25 for attaching the first filter 6 and second filter receiving portions 26 for attaching second filters 7. The first member 4 includes engagement claws 9a at right and left end portions on the front side surface thereof, and the three engagement holes 10b at the lower portion on the rear surface side. The first member 4 includes a maintenance connection portion 17 at a right end portion of the upper surface thereof, and an upper portion of the maintenance connection portion 17 is closed by a cap 15 via packing 16. The first member 4 includes engagement holes 19 at both end portions of the lower surface thereof.

The second member 5 includes protrusions 18 at both end portions of the upper surface thereof, two engagement holes 10a at both end portions on the front side thereof, and the three engagement claws 9b (not shown) at the side surface on the rear surface side thereof. The first member 4 and the second member 5 are bonded to each other by fitting the two protrusions 18 into the two engagement holes 19, engaging the two engagement claws 9a with the two engagement holes 10a, engaging the three engagement claws 9b with the three engagement holes 10b, and applying an adhesive to the respective fitting portions and the respective engaging portions. With this, the flow path 8 and the discharge port 12 are formed between the first member 4 and the second member 5. Note that, the flow path member 2 illustrated in FIGS. 3A, 3B, and 4 is merely an example of this embodiment, and it is sufficient as long as the flow path member can guide the supplied liquid to the actuator portion 3, and the parting lines are not positioned on the inner surface forming the flow path and are positioned on the outer surface or the bonding surface.

FIG. 5 is a schematic perspective view illustrating the discharge-port-side end surface TR of the flow path member 2, on which the discharge port 12 opens. The discharge port 12 is formed between the first member 4 and the second member 5. The discharge-port-side end surface TR has a groove 28 formed around the discharge port 12. The groove 28 is provided to completely seal the flow path 8 from the outside and firmly adhere the flow path member 2 and the actuator portion 3 to each other when the inflow-port-side end surface TG and the discharge-port-side end surface TR are bonded to each other with the adhesive 13.

Here, the first and second parting lines P11 and P21 of the first and second members 4 and 5 are positioned at the opening end portion of the discharge port 12, and the opening end portion is covered with the adhesive 13. Further, on the discharge-port-side end surface TR, the first and second parting lines P11 and P21 are positioned at the bonding surface between the first member 4 and the second member 5. Note that, the first parting line P11 can be formed at any position between the upper end and the lower end of the discharge-port-side end surface TR of the first member 4. Similarly, the second parting line P21 can be formed at any position between the upper end and the lower end of the discharge-port-side end surface TR of the second member 5. That is, the first and second parting lines P11 and P21 are not necessarily positioned at the opening end portion of the discharge port 12, and may be formed so as to be positioned at the discharge-port-side end surface TR of the first and second members 4 and 5 other than the opening end portion of the discharge port 12.

### Method of Manufacturing Liquid Jet Head

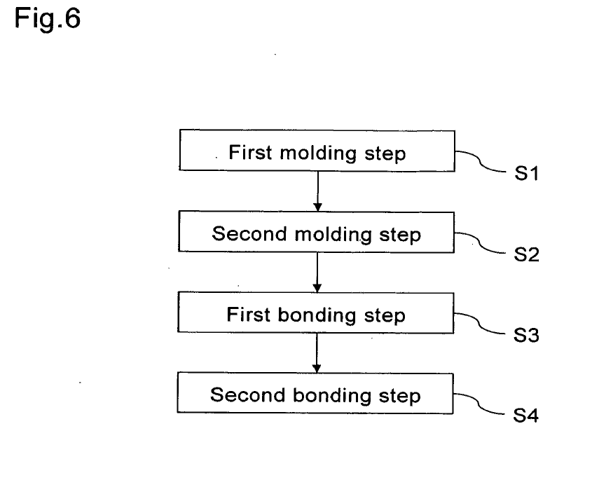

FIG. 6 is a process chart illustrating basic steps of a method of manufacturing a liquid jet head according to the present invention. First, in a first molding step S1, a synthetic resin is filled into a space defined by a first mold, a second mold, and a third mold to perform molding. Next, the first mold, the second mold, and the third mold are removed to take out the first member. The first mold, the second mold, and the third mold are formed so that the first parting lines of the molded first member, which are formed at the boundary between any two of the first mold, the second mold, and the third mold, are to be positioned at other than the inner surface forming the flow path. In a second molding step S2, a synthetic resin is filled into a space defined by a fourth mold and a fifth mold to perform molding. Next, the fourth mold and the fifth mold are removed to form the second member. The fourth mold and the fifth mold are formed so that the second parting lines of the molded second member, which are formed at the boundary between the fourth mold and the fifth mold, are to be positioned at other than the inner surface forming the flow path.

Next, in a first bonding step S3, the first member and the second member are bonded to each other so that the flow path and the discharge port communicated to the flow path are formed between the first member and the second member. The bonding may be performed with the use of an adhesive, or may be performed by other methods such as heat welding. Next, in a second bonding step S4, an end surface of the flow path member, on which the discharge port opens, and an end surface of the actuator portion, on which the inflow port opens, are bonded to each other with an adhesive. In this manner, the first and second parting lines are not positioned on the inner surface of the flow path member forming the flow path. Therefore, it is possible to prevent ejection failure which occurs because the openings of the nozzles are clogged with fine burrs which are generated at the parting lines and drop off from the flow path member.

Note that, in the first bonding step S3, the first and second parting lines are formed on the discharge-port-side end surface, on which the discharge port opens. In particular, even when the first or second parting line is positioned at the opening end portion of the discharge port, the opening end portion is covered with an adhesive in the second bonding step S4. As a result, the fine burrs which drop off from the parting line do not enter the flow path. Further, in the first bonding step S3, the first member and the second member can be bonded to each other so that the first parting lines and the second parting lines are covered with the second member or the first member, and thus the parting lines can be formed without being exposed to the flow path. Hereinafter, the method of manufacturing a liquid jet head of the present invention is described in detail with reference to the drawings.

### Second Embodiment

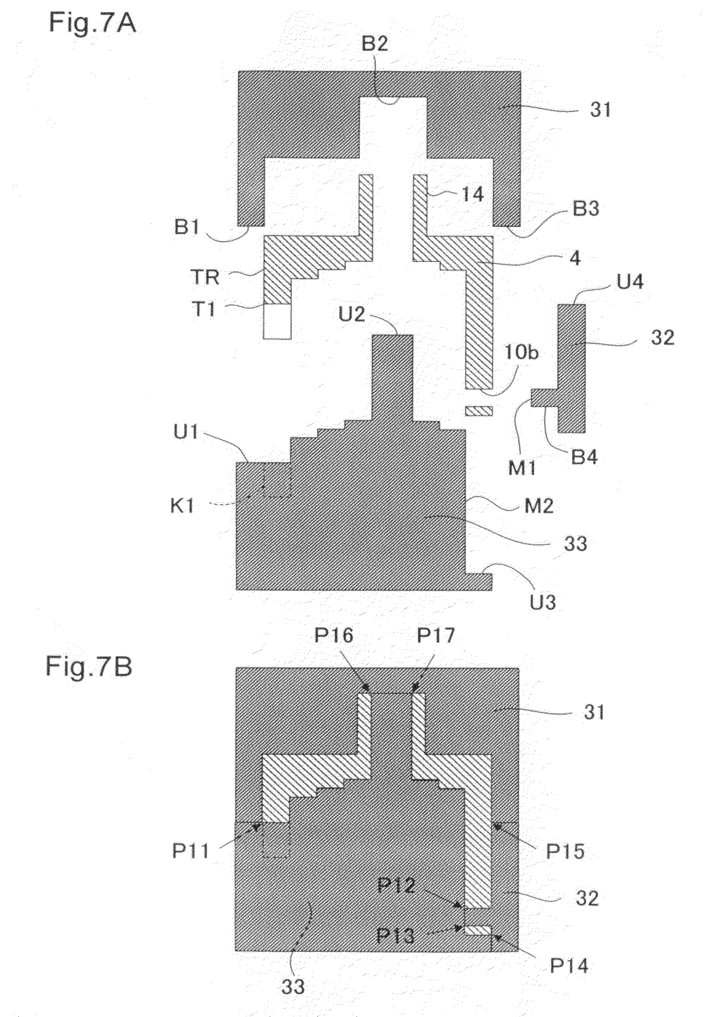

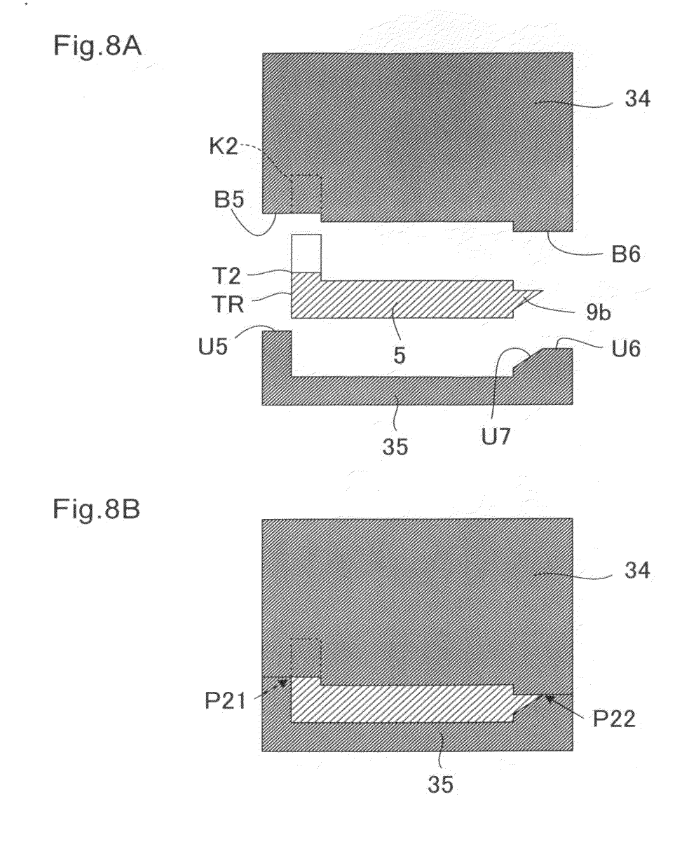

FIGS. 7A, 7B, 8A, and 8B are views illustrating a method of manufacturing a liquid jet head according to a second embodiment of the present invention. FIGS. 7A and 7B are views illustrating the first molding step S1, of which FIG. 7A is an exploded view of the molds and FIG. 7B is an assembly view of the molds. Both of FIGS. 7A and 7B illustrate a longitudinal section in a short-side direction. A space is defined by a first mold 31, a second mold 32, and a third mold 33, and a synthetic resin is filled into the space to form the first member 4. The section of the first member 4 in the short-side direction has a form of Japanese Katakana “ [symbol] ”. The first mold 31 on the upper side includes a first lower end surface B1 provided at a lower portion of a left end portion thereof, a third lower end surface B3 provided at a lower portion of a right end portion thereof, and a recessed portion forming a second lower end surface B2, which is upwardly recessed compared to the periphery and provided at a center portion thereof. The third mold 33 on the lower side includes a first recess K1 provided in the vicinity of a left end portion thereof, a first upper end surface U1 provided at an upper portion of the left end portion thereof, a protruded portion, which has an upper portion forming a second upper end surface U2 and is provided at a center portion thereof, and a third upper end surface U3 provided at a right end portion thereof. The second mold 32 on the right side includes a fourth upper end surface U4 provided at an upper surface thereof, a side surface M1 provided at a leading end of an inwardly protruded portion thereof, and a fourth lower end surface B4 provided at a lower portion of the protruded portion thereof. When the first mold 31, the second mold 32, and the third mold 33 are assembled, a space as illustrated in FIG. 7B is formed, and the synthetic resin is filled into the space.

In this case, the first lower end surface B1 of the first mold 31 abuts against the first upper end surface U1 of the third mold 33, and a boundary surface therebetween forms the first parting line P11. Similarly, the boundary between the third lower end surface B3 of the first mold 31 and the fourth upper end surface U4 of the second mold 32 forms the first parting line P15. The boundary between the side surface M1 of the second mold 32 and a side surface M2 on the right side of the third mold 33 forms the first parting lines P12 and P13. The boundary between the fourth lower end surface B4 of the second mold 32 and the third upper end surface U3 of the third mold 33 forms the first parting line P14. Further, at the boundary between the second lower end surface B2 of the first mold 31 and the second upper end surface U2 of the third mold 33, that is, at the opening end portion of the supply connection portion 14, first parting lines P16 and P17 are formed.

Here, an upper opening end portion T1, which forms the end portion of the discharge port 12 of the first member 4, coincides with the first parting line P11. Further, the first recess K1 of the third mold 33 corresponds to a side surface for supporting the engagement claws 9a formed at both the end portions in the long-side direction illustrated in FIG. 3B. Further, the recessed portion at the center of the first mold 31 and the protruded portion at the center of the third mold 33 form the supply connection portion 14. Further, a stepped portion formed in the periphery of the protruded portion at the center of the third mold 33 forms the receiving portion to which the first filter is attached.

Note that, in the above-mentioned embodiment, the first parting line P11 is formed so as to coincide with the upper opening end portion T1, but the present invention is not limited thereto. The upper opening end portion T1 of the first member 4 may be formed by a recess such as the first recess K1. In this case, the first parting line P11 is formed on the discharge-port-side end surface TR on the left side of the first member 4. That is, the first parting line P11 may be formed on the discharge-port-side end surface TR at a position apart from the discharge port 12.

FIGS. 8A and 8B are views illustrating the second molding step S2, of which FIG. 8A is an exploded view of the molds and FIG. 8B is an assembly view of the molds. Both of FIGS. 8A and 8B illustrate a longitudinal section in the short-side direction. A space is defined by a fourth mold 34 and a fifth mold 35, and a synthetic resin is filled into the space to form the second member 5. The fourth mold 34 on the upper side includes a second recess K2 provided at a lower portion of a left end portion thereof, a fifth lower end surface B5 provided at the lower portion of the left end portion thereof, and a sixth lower end surface B6 provided at an upper portion of a step on a lower portion of a right end portion thereof. The fifth mold 35 on the lower side includes a fifth upper end surface U5 provided at an upper end of a recessed portion on the left side thereof, a sixth upper end surface U6 provided at an upper end of the recessed portion on the right side thereof, and an inclined surface U7, which is inclined to the inner side of the recessed portion and is communicated to the sixth upper end surface U6. When the fourth mold 34 and the fifth mold 35 are assembled, as illustrated in FIG. 8B, a space is defined by the bottom center portion of the fourth mold 34 and the bottom surface of the recessed portion of the fifth mold 35, and the synthetic resin is filled into the space.

In this case, the fifth lower end surface B5 of the fourth mold 34 abuts against the fifth upper end surface U5 of the fifth mold 35, and a boundary surface therebetween forms the second parting line P21. Similarly, a boundary surface between the sixth lower end surface B6 of the fourth mold 34 and the sixth upper end surface U6 of the fifth mold 35 forms the second parting line P22. Further, the fifth lower end surface B5 of the fourth mold 34 forms a lower opening end portion T2 which becomes the lower portion of the discharge port 12 of the second member 5. Further, the sixth lower end surface B6 of the fourth mold 34 and the inclined surface U7 of the fifth mold 35 form the engagement claws 9b illustrated in FIG. 1, and the second parting line P22 is formed at the leading end thereof. Further, the second recess K2 of the fourth mold 34 forms providing portions for the engagement holes 10a illustrated in FIG. 3B.

Note that, in the above-mentioned embodiment, the second parting line P21 is formed so as to coincide with the lower opening end portion T2, but the present invention is not limited thereto. The lower opening end portion T2 of the second member 5 may be formed by a recess such as the second recess K2. In this case, the second parting line P21 is formed on the discharge-port-side end surface TR on the left side of the second member 5. That is, the second parting line P21 may be formed on the discharge-port-side end surface TR at a position apart from the discharge port 12.

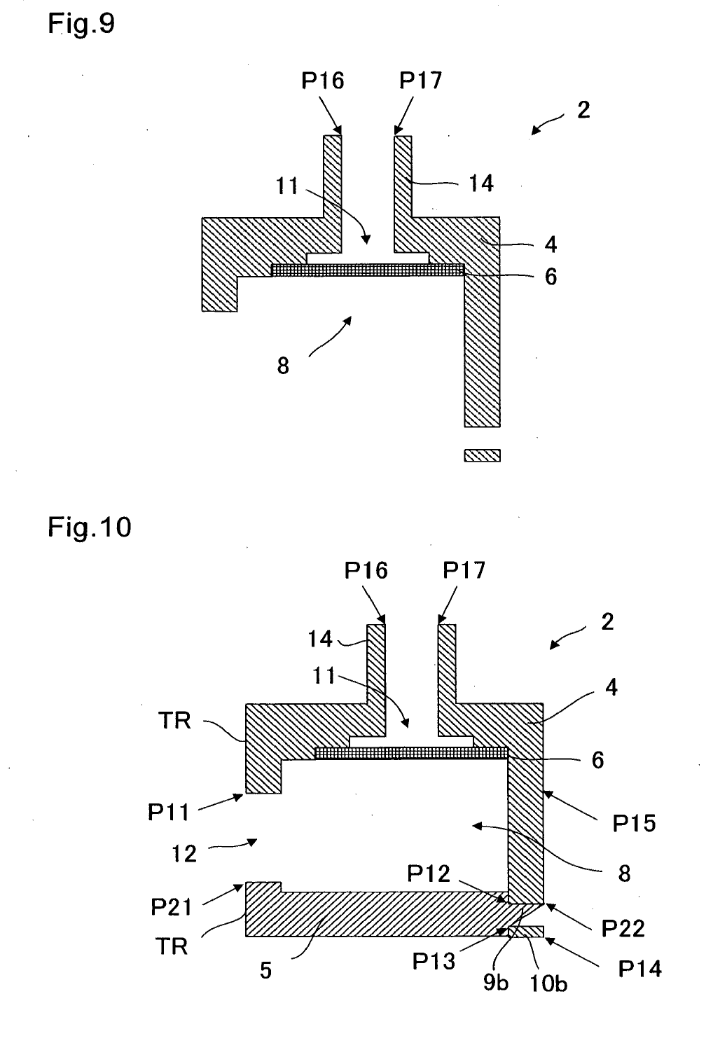

FIG. 9 is a longitudinal sectional view of the first member 4 obtained after the filter providing step. The first member 4 and the first filter 6 are immersed in cleaning liquid to perform ultrasonic cleaning. Next, the first filter 6 is provided immediately below the supply port 11 of the first member 4. The first filter 6 is provided to remove dust or air bubbles included in the liquid supplied from the liquid tank. The removal is performed because dust or air bubbles having a size larger than that of the opening portion of the nozzle may close the nozzle to cause ejection failure. The first filter 6 is bonded to the first member 4 by, for example, heat welding. Alternatively, the bonding may be performed by using an adhesive instead of heat welding.

The first parting lines P16 and P17 are formed also at the end portion of the supply connection portion 14. As defined at the beginning, the corner portion of the opening portion of the supply connection portion 14 is not included in the flow path 8. However, depending on a method of connecting the supply connection portion 14 and a tube or a pipe for supplying liquid, the first parting lines P16 and P17 may contact to the liquid. Also in such a case, by providing the first filter 6, the fine burrs generated at the first parting lines P16 and P17 may be removed. Therefore, when the first filter 6 is provided, it is only necessary to perform molding so that the first and second parting lines P11 and P21 are not positioned on the inner surface of the flow path member 2 forming the flow path 8 on the downstream side with respect to the first filter 6. Further, in a case where the second filters 7 illustrated in FIG. 3B are provided, the second filters 7 are provided to the first member 4 before the first filter 6 is provided, and then the first filter 6 is provided to the first member 4.

FIG. 10 is a longitudinal sectional view of the flow path member 2 obtained after the first bonding step S3. First, the first member 4, the second member 5, and the first filter 6 provided to the first member 4 are cleaned. Next, the first member 4 and the second member 5 are bonded to each other to form the flow path 8 and the discharge port 12 communicated thereto between the first member 4 and the second member 5, and thus the flow path member 2 is formed. The engagement claws 9b of the second member 5 are engaged with the engagement holes 10b of the first member 4, and the engagement claws 9a (not shown) of the first member 4 are engaged with the engagement holes 10a (not shown) (see FIG. 4) of the second member 5. Bonding is then performed with an adhesive. As a result, the first parting line P11 and the second parting line P21 are positioned at the end portion of the discharge port 12. The end portion is covered with an adhesive later at the time of bonding with the actuator portion 3, and hence is unexposed to the flow path 8. Further, the first parting lines P12 and P13 are covered with the second member 5, and the first parting lines P14 and P15 and the second parting line P22 are positioned on the outer surface of the flow path member 2, and hence those parting lines are unexposed to the flow path 8.

Note that, description has been made of the bonding in the short-side direction of the flow path member 2, but also in the case of bonding of the first member 4 and the second member 5 in the long-side direction of the flow path member 2, the first to fifth molds 31 to 35 may be formed so that the parting lines are positioned on the bonding surface of the first member 4 or the second member 5 or the outer surface of the flow path member 2.

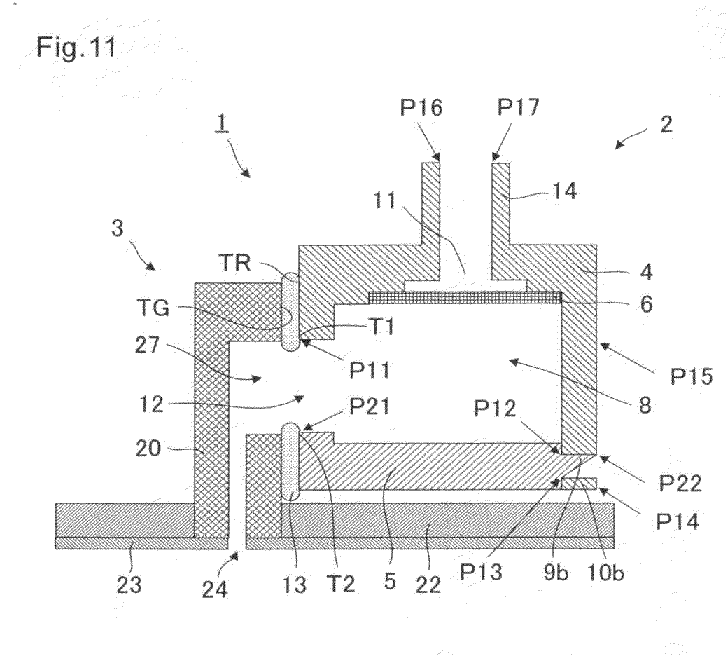

FIG. 11 is a longitudinal sectional view of the flow path member 2 and the actuator portion 3 obtained after the second bonding step S4. The discharge-port-side end surface TR of the flow path member 2, on which the discharge port 12 opens, and the inflow-port-side end surface TG of the actuator portion 3, on which the inflow port 27 opens, are bonded to each other with the adhesive 13. With this bonding, even when the first parting line P11 and the second parting line P21 are positioned at the upper opening end portion T1 and the lower opening end portion T2 of the discharge port 12, those parting lines are unexposed to the flow path 8. Therefore, the burrs generated at the first and second parting lines P11 and P21 do not flow into the actuator portion 3 side. Note that, the structure of the actuator portion 3 has been described in the first embodiment, and hence description thereof is omitted here.

Note that, an elongated protrusion may be formed to the first mold 31 and the fourth mold 34 at the end surfaces on which the discharge port 12 opens so as to surround the discharge port 12, to thereby form the groove 28 (see FIG. 5) around the discharge port 12 of the first member 4 and the second member 5.

The liquid jet head 1 is manufactured as described above, and hence the parting lines are unexposed to the flow path 8 of the flow path member 2 on the downstream side with respect to the first filter 6. Therefore, it is possible to prevent ejection failure which occurs because the openings of the nozzles 24 are clogged with the fine burrs, which are generated at the parting lines and drop off from the flow path member. Note that, description has been made of an example in which three molds are used to form the first member 4 and two molds are used to form the second member 5, but this is the minimum number of molds required for the present invention, and the number of molds may be increased from this number.

### Liquid Jet Apparatus

### Third Embodiment

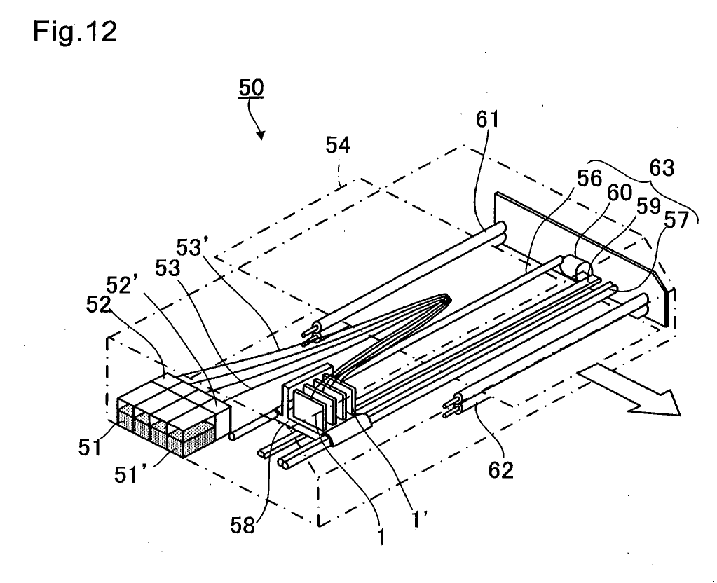

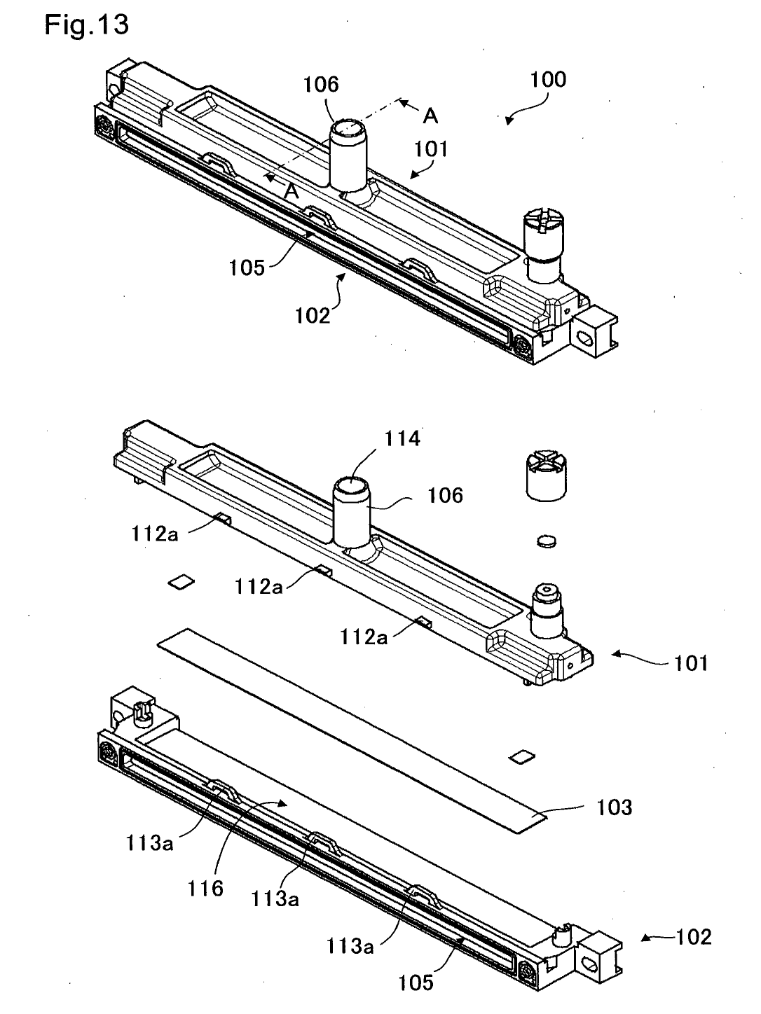

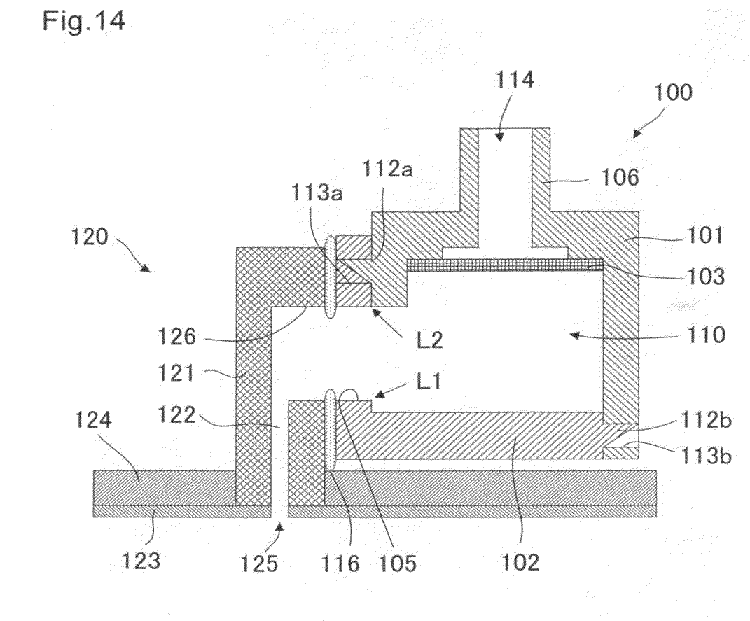

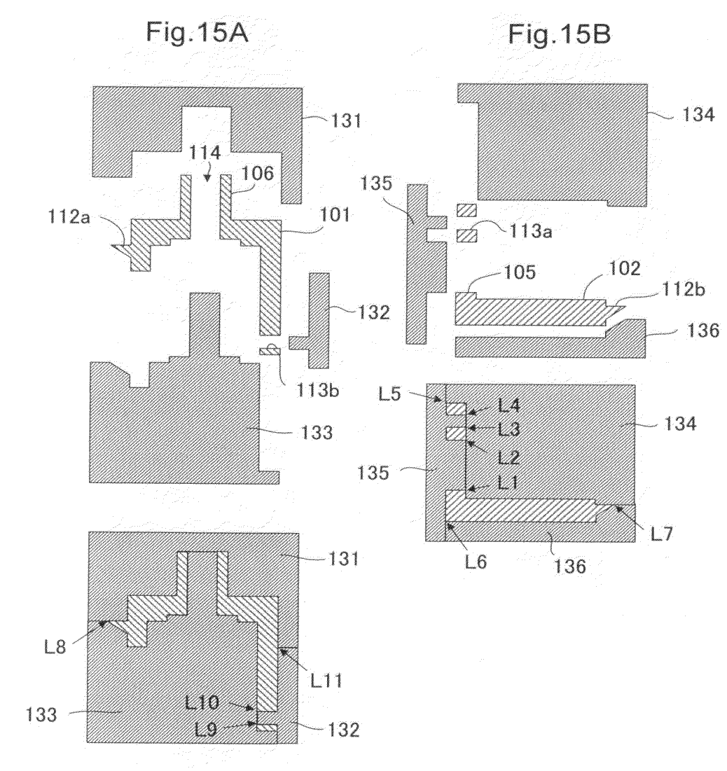

FIG. 12 is a schematic perspective view of a liquid jet apparatus 50 according to a third embodiment of the present invention. The liquid jet apparatus 50 uses the liquid jet head 1 described in the first or second embodiment above. The liquid jet apparatus 50 includes a moving mechanism 63 for reciprocating liquid jet heads 1 and 1′, liquid supply tubes 53 and 53′ for supplying liquid to the liquid jet heads 1 and 1′, respectively, and liquid tanks 51 and 51′ for supplying the liquid to the liquid supply tubes 53 and 53′, respectively. The liquid jet heads 1 and 1′ each include the actuator portion 3 for ejecting the liquid, the flow path member 2 for supplying the liquid to the actuator portion 3, and a pressure damper (not shown) for supplying the liquid to the flow path member 2.

Specific description is given below. The liquid jet apparatus 50 includes a pair of transport means 61 and 62 for transporting a recording medium 54 such as paper in a main scanning direction, the liquid jet heads 1 and 1′ for ejecting liquid onto the recording medium 54, pumps 52 and 52′ for pressing the liquid stored in the liquid tanks 51 and 51′ to supply the liquid to the liquid supply tubes 53 and 53′, respectively, and the moving mechanism 63 for moving the liquid jet heads 1 and 1′ to perform scanning in a sub-scanning direction orthogonal to the main scanning direction.

The pair of transport means 61 and 62 each extend in the sub-scanning direction, and include a grid roller and a pinch roller that rotate with their roller surfaces coming into contact with each other. The grid roller and the pinch roller are rotated about their shafts by means of a motor (not shown) to transport the recording medium 54 sandwiched between the rollers in the main scanning direction. The moving mechanism 63 includes a pair of guide rails 56 and 57 extending in the sub-scanning direction, a carriage unit 58 capable of sliding along the pair of guide rails 56 and 57, an endless belt 59 to which the carriage unit 58 is connected for moving the carriage unit 58 in the sub-scanning direction, and a motor 60 for revolving the endless belt 59 through pulleys (not shown).

The carriage unit 58 has the plurality of liquid jet heads 1 and 1′ placed thereon, and ejects liquid droplets of four types, for example, yellow, magenta, cyan, and black. The liquid tanks 51 and 51′ store liquid of corresponding colors, and supply the liquid through the pumps 52 and 52′ and the liquid supply tubes 53 and 53′ to the liquid jet heads 1 and 1′, respectively. A control portion of the liquid jet apparatus 50 sends a drive signal to the liquid jet heads 1 and 1′ to cause the liquid jet heads 1 and 1′ to eject the liquid droplets of the respective colors. The control portion controls the timing to eject the liquid from the liquid jet heads 1 and 1′, the rotation of the motor 60 for driving the carriage unit 58, and the transport speed of the recording medium 54, to thereby record an arbitrary pattern onto the recording medium 54.

In this embodiment, the parting lines, which are generated at the time of molding, are unexposed to the flow path of the flow path member. Therefore, it is possible to provide the liquid jet apparatus 50 which is capable of preventing ejection failure which occurs because the openings of the nozzles are clogged with fine burrs which are generated at the parting lines and drop off from the flow path member.

What is claimed is:

1. A liquid jet head, comprising:
a flow path member comprising a first member and a second member bonded to the first member, the first member and the second member forming a flow path and a discharge port communicated to the flow path between the first member and the second member; and
an actuator portion, into which liquid discharged from the discharge port flows, for ejecting the liquid from a plurality of nozzles, wherein:
the first member and the second member each include a parting line formed by molding on a surface thereof; and
the parting line is positioned on the surface of one of the first member and the second member other than an inner surface forming the flow path.

2. A liquid jet head according to claim 1, wherein:
the discharge port opens on an end surface of the flow path member; and
the parting line is positioned on the end surface.

3. A liquid jet head according to claim 2, wherein:
the actuator portion includes an inflow port at an end surface thereof;
the end surface of the actuator portion and the end surface of the flow path member are bonded to each other with an adhesive; and
the parting line positioned on the end surface of the flow path member is covered with the adhesive.

4. A liquid jet head according to claim 3, wherein the end surface of the flow path member includes a groove, which is provided so as to surround the discharge port, for causing the adhesive to flow.

5. A liquid jet head according to claim 1, wherein:
the first member comprises a supply port communicated to the flow path and a filter provided on a downstream side with respect to the supply port; and
the inner surface comprises a surface positioned on a downstream side with respect to the filter on the discharge port side.

6. A liquid jet apparatus, comprising:
the liquid jet head according to claim 1;
a moving mechanism for reciprocating the liquid jet head;
a liquid supply tube for supplying liquid to the liquid jet head; and
a liquid tank for supplying the liquid to the liquid supply tube.

7. A method of manufacturing a liquid jet head, comprising:
a first molding step of filling a synthetic resin into a space defined by a first mold, a second mold, and a third mold to mold a first member;
a second molding step of filling a synthetic resin into a space defined by a fourth mold and a fifth mold to mold a second member;
a first bonding step of bonding the first member and the second member so that a flow path and a discharge port communicated to the flow path are formed between the first member and the second member, to thereby form a flow path member; and
a second bonding step of bonding an end surface of the flow path member, on which the discharge port opens, and an end surface of an actuator portion, on which an inflow port opens, with an adhesive, wherein:
the first molding step comprises forming a first parting line on a surface of the first member other than an inner surface forming the flow path, the first parting line being formed at a boundary between any two of the first mold, the second mold, and the third mold; and
the second molding step comprises forming a second parting line on a surface of the second member other than the inner surface forming the flow path, the second parting line being formed at a boundary between the fourth mold and the fifth mold.

8. A method of manufacturing a liquid jet head according to claim 7, wherein:
the first molding step comprises forming the first parting line on the end surface on which the discharge port opens; and
the second molding step comprises forming the second parting line on the end surface on which the discharge port opens.

9. A method of manufacturing a liquid jet head according to claim 7, wherein the first bonding step comprises covering the second parting line with the first member and covering the first parting line with the second member.

10. A method of manufacturing a liquid jet head according to claim 8, wherein the second bonding step comprises embedding the first parting line and the second parting line, which are formed on the end surface on which the discharge port opens, in the adhesive.

11. A method of manufacturing a liquid jet head according to claim 7, further comprising, after the first molding step, a filter, providing step of providing a filter to the first member.

12. A method of manufacturing a liquid jet head according to claim 7, wherein the first mold and the fourth mold include an elongated protrusion on surfaces thereof, which correspond to the end surface on which the discharge port opens.
